(19) United States
(12) Patent Application Publication
(10) Pub. No.: US 2010/0242225 A1
(43) Pub. Date: Sep. 30, 2010

(54) PNEUMATIC DOOR CLOSER

(75) Inventors: Andrew John Teatuario Terei, Taringa (AU); Peter Gordon Sclater, Middle Park (NZ); Michael Barry des-David, Cleveland (AU)

Correspondence Address: LAW OFFICE OF DELIO & PETERSON, LLC., 121 WHITNEY AVENUE, NEW HAVEN, CT, 06510, US

(73) Assignee: Assa Abloy Australia Pty Limited, Oakleigh (AU)

(21) Appl. No.: 12/732,474

(22) Filed: Mar. 26, 2010

(30) Foreign Application Priority Data
Mar. 27, 2009 (AU) AU2009901330

(51) Int. Cl. E05F 3/02

(52) U.S. Cl. 16/66

(57) ABSTRACT

A pneumatic door closer which includes a cylinder which has a first end and an opposed second end; a piston which is slidingly engaged with the cylinder and which is biased towards the first end; a valve plug, a valve seat and a biasing member to bias the valve plug into sealing engagement with the valve seat to regulate the flow of air from the cylinder; and an adjustable assembly associated with the valve plug to vary the biasing force exerted on the valve plug thereby varying level of air pressure required inside the chamber before the valve plug is disengaged from the valve seat so that air is allowed to escape from the cylinder.

### TECHNICAL FIELD

The invention described herein relates generally to a door closer and more particularly is concerned with a pneumatic door closer which includes a one way valve which is pressure sensitive although the scope of the invention is not necessarily limited thereto.

### BACKGROUND ART

A typical pneumatic door closer consists of a cylinder closed at one end with a piston mounted inside the cylinder so that a chamber is formed between the piston and the closed end. The piston is biased towards the closed end with a compression spring. The pneumatic door closer is secured at one end to a door and at an opposed end to structure such as a door frame.

Movement of the door away from the door frame causes the piston to move away from the closed end. The door is moved, under the biasing force of the compression spring, towards the closed end so that the door is caused to close under the operation of the pneumatic door closer.

Movement of the piston towards the closed end causes air contained inside the chamber to be pressurized. The pressurized air counters the biasing force of the compression spring so that once the air inside the chamber has been pressurized to a certain level, movement of the piston towards the closed end under the biasing force of the compression spring is prevented through the pressurized air.

The pneumatic door closer includes a small bleed hole in proximity to the closed end which allows air to escape gradually form the chamber. This allow controlled movement of the piston towards the closed end, under the biasing force of the compression spring, as air is allowed to escape form the chamber through the bleed hole.

A pneumatic door closer with a bleed hole configured to only allow a maximum volume of air therethrough and may cause the door to “bounce” when the door is released from a position at which the door has been opened substantially to a maximum extent. This is due to the bleed hole being not large enough to release the sudden increase in air pressure inside the chamber. The compression spring is compressed close to a maximum extent when the door is opened fully. When the door is released from the open position, the compression spring causes the piston to move at an accelerated velocity towards the closed end thereby rapidly increasing the air pressure inside the chamber. The size of the bleed hole may be such so that the increase in air pressure is not properly vented. Consequently, the rapid movement of the piston towards the closed end results in the air being pressured to a level which is greater than the biasing force of the compression spring so that the piston is caused to move away from the closed end against the biasing force of the compression spring. This may be undesirable.

It is an aim of the invention to provide a pneumatic door closer which overcomes or ameliorates one or more of the disadvantages or problems described above, or which at least provides the consumer with a useful choice.

### SUMMARY OF THE INVENTION

According to an aspect of the invention, there is provided a pneumatic door closer which includes a cylinder which has a first end and an opposed second end; a piston which is slidingly engaged with the cylinder and which is biased towards the first end; a valve plug, a valve seat and a biasing member to bias the valve plug into sealing engagement with the valve seat to regulate the flow of air from the cylinder; and an adjustable assembly associated with the valve plug to vary the biasing force exerted on the valve plug thereby varying level of air pressure required inside the chamber before the valve plug is disengaged from the valve seat so that air is allowed to escape from the cylinder.

The adjustment assembly allows a user or installer of the door closer to adjust the position of the valve plug to longitudinally relative to the valve seat by altering the biasing force of the biasing member. The biasing force applied to the valve plug allows a degree of movement of the valve plug longitudinally away from the valve seat. Typically the increase in air pressure inside the chamber will exert a force on the valve plug which opposes the biasing force. As the pressure inside the chamber increases, so does the force being applied to the valve plug by the pressurised air so that valve plug and the valve seat are pushed further apart against the biasing force of the adjustable member. This longitudinal movement of the valve plug relative to the valve seat can accommodate, at least to some extent, the initial increase in air pressure inside the chamber when the door is released from the open position. The air pressure will move the valve plug away from the valve seat until the biasing force becomes great enough that the air pressure in the cylinder cannot move the valve plug any further. There follows a period of relative equilibrium where the biasing force and the air pressure are approximately equal and then, as the air pressure in the cylinder drops, the valve plug will be forced back to the valve seat by the biasing force.

The cylinder may be formed from any suitable material which will allow the chamber to be pressurized without the cylinder failing under such pressure. Normally the cylinder is manufactured of a light metal.

The door closer may be secured in any suitable configuration to structure such as a door or a frame to which the door is pivotally attached. Movement of the door relative to the frame may cause the piston to move inside the chamber. In one embodiment, the cylinder extends between the door and the frame in such a way so that the first end is facing the frame and the second end faces the door. Alternatively, the orientation of the cylinder is reversed so that the first end faces the door and the second end faces the door.

The cylinder may be secured to the door and the frame in such a way so that the piston is caused to move inside the chamber when the door is moved relative to the frame. In one embodiment, suitable brackets are attached respectively to the door and to the frame so that the first end is securable to the frame and the piston to the door, by attaching the cylinder containing the piston to the door.

The piston is typically mounted coaxially inside the cylinder using a rod which is securable to the bracket. In this embodiment, the first end of the cylinder may be securable to a bracket using any appropriate fastener or using a suitable formation formed on the cylinder which allows the first end of the cylinder to be engaged with the respective bracket. In a different embodiment, the cylinder includes a suitable bracket which is integrally formed with the cylinder during manufacture thereof or which is secured during manufacture to the cylinder, and with which the cylinder is securable at the first end to the frame, or more preferably, to the door. In either embodiment, suitable fasteners may be used to secure the brackets or the cylinder to the door or the frame.

The piston may be engaged with the cylinder in any suitable way which allows the piston to reciprocate inside the cylinder. In one embodiment, a second end of the cylinder which opposes the first end is configured to allow the piston to move longitudinally inside the cylinder without allowing the piston to be removed from the cylinder. In this embodiment, the rod mounting the piston is attached to a trailing end of the piston which faces the second end of the cylinder and with which the piston is caused to move longitudinally inside the cylinder. The rod may be secured at a free end to structure such as the door or the door frame through the respective brackets. The rod extends through an opening in an end cap provided on the second end of the cylinder. This opening will normally have an annular sealing means to seal about the rod.

A biasing means is preferably provided to cause the piston to move back towards the first end when, for example, the door is released from an open position. In one embodiment, a compression spring is positioned inside the cylinder and between the piston and the second end of the cylinder. The compression spring will typically abut the piston and the end cap at the second end of the cylinder. The rod may extend through the compression spring. In another embodiment one or more extension or tension springs may be secured at one end to the first end and at an opposed end to the piston.

Any suitable technique may be used to allow air to move into the chamber when the piston is caused to move away from the first end. In one embodiment, the piston may be configured to allow air to move into the chamber when the piston is moved away from the first end and to sealingly engage with an inner wall of the cylinder when the piston is moved towards the first end. In another embodiment, the cylinder may contain any suitable arrangement which allows air to flow into the chamber but which prevents air to flow from the chamber. For example, a one way valve may be attached to the cylinder at a suitable position so that air is allowed to move into the chamber when the piston is caused to move away from the first end but which prevents air to escape from the chamber when air inside the chamber is pressurized. Typically, opening the door will cause the piston to move towards the second end of the cylinder thereby creating a partial vacuum in the cylinder which will draw air in from outside the cylinder.

The adjustment assembly is preferably associated with the first end of the cylinder and may be associated in any suitable way which will allow the chamber to be pressurized when the piston is caused to move towards the first end. The adjustment assembly may be integrally formed with cylinder or may be attached to the first end using any suitable technique such as punching, welding or the like. Typically, a portion of the adjustment assembly will form an end cap for closing the first end of the cylinder.

Any suitable technique may be used to bias the valve plug into engagement with at least part of the valve seat. For example, a member which can be resiliently compressed, such as a spring or the like, may be used to bias the valve plug towards the valve seat.

In a particularly preferred embodiment, the adjustment assembly includes a valve body which is crimped onto the first end. The valve body has a passage which extends therethrough from an inner end of the valve body, which is adjacent or may form the end cap at, the first end of the cylinder, to an outer end of the valve body. The passage has a first portion which is flared towards the outer end of the valve body to form the valve seat so that a cross sectional diameter of the valve seat gradually increases from the inner end to the outer end.

The valve plug is preferably cone-shaped and is dimensioned so that the profile of the valve plug matches that of the valve seat. Put another way, the valve seat and the valve plug normally have complementary shapes. This may increase the effectiveness of the seal which is created between the valve plug and the valve seat. The valve plug preferably has an elongate attachment neck extending from its base which is typically oriented outwardly. Normally, the biasing spring will be seated about the attachment neck.

The passage further includes a second portion which extends from the first portion to the outer end. A section of the valve body contains a screw thread formation which is complimentary to and interengageable with a screw thread formation of the adjustable member so that the adjustable member can be screwed onto the valve body. A compression spring is positioned between the adjustable member and the valve plug so that the valve plug is biased by the compression spring into sealing engagement with the valve seat. The second portion of the passage normally also diverges as it extends towards the outer end.

In the most preferred embodiment, the valve body is cylindrical and has an externally threaded portion.

The adjustment assembly also preferably includes an adjustment member typically a rotatable knob or similar, located at an outermost end of the adjustment assembly. The adjustment member will preferably be operatively associated with the valve plug and the biasing means of the valve assembly to adjust the actuating pressure required to open the valve by disengaging the valve plug from the valve seat.

The adjustment member is movably, normally rotatably engaged with the externally threaded portion of the valve body. As such, the adjustment member normally includes an internally threaded portion to engage the valve body.

The adjustment member preferably has a cap shaped with an outer or base wall with a peripheral side wall extending substantially perpendicular to the outer wall. The side wall will preferably contain or cover the components of the adjustment assembly to protect them from accidental damage. The outer wall will preferably include one or more openings. In a preferred embodiment, a single, substantially central opening is provided. On an inner surface of the outer wall and surrounding the substantially central opening, a preferably annular retaining ring is provided, typically standing proud of the inner surface. The retaining ring will preferably engage an opposite end of the compression spring which mounts the valve plug.

Alternatively, the adjustment member may be moveably engaged with a portion of the cylinder itself.

The amount of biasing force exerted on the valve plug can be varied using any suitable movement relative to the cylinder of the adjustable member. For example, the adjustment member may be rotated relative to the cylinder, pivoted relative to the cylinder, or moved towards or away from the cylinder.

In the particularly preferred embodiment, the adjustment member is screwed onto the valve body. The compression spring is positioned between the valve plug and the adjustment member so that rotational movement of the adjustment member towards the first end, causes the level of compression in the compression spring to increase, by shortening the effective length of the spring. Conversely, movement of the adjustable member away from the first end decreases level of compression in the compression spring, by increasing the effective length of the spring. By adjusting the effective length of the spring when the valve plug is seated in the valve seat, the amount of force with which the valve plug is biased towards the valve seat and the amount of force required to disengage the valve plug from the valve seat, can be varied.

The cylinder may include a formation which allows the remaining air pressure inside the chamber to escape so that substantially all of the air pressure inside the chamber is dissipated when the piston reaches a predetermined position inside the cylinder. In one embodiment, a groove or portion of greater diameter is formed in an inner side wall of the cylinder which allows the air to move past the piston when the piston is at a predetermined position relative to the first end. Typically, this portion of greater diameter is located towards but not at, the first end of the cylinder. This portion will also preferably allow the air to escape quickly enough to allow the door to close quickly at the end of the closing cycle as this may be required in order to allow a latchset associated with the door to be properly actuated.

In the context of this specification the term “bounce” is meant to refer to when a door which has been allowed to move under the influence of a pneumatic door closer particularly towards a closed position, to be pushed back towards an open position by the pneumatic door closer as a result of excessive air pressure building up inside a chamber of the pneumatic door closer, which cannot escape quickly enough from the cylinder.

### BRIEF DESCRIPTION OF THE DRAWINGS

The invention is now described, by way of example only, with reference to the drawings. The following description is not intended to limit the scope of the preceding summary or the claims.

FIG. 1 is a cross sectional side view of a pneumatic door closer according to the invention.

FIG. 2 is a cross sectional side view of the pneumatic door closer in which a piston is moved some distance away from a first end of a cylinder of the door closer.

FIG. 3 is an enlarged view of part of the pneumatic door closer of FIG. 1 which is identified with a circle which is numbered 3.

FIG. 4 is an enlarged view of part of the pneumatic door closer of FIG. 2 which is identified with a circle which is numbered 4.

FIG. 5 is a side view of an arrangement used in the pneumatic door closer.

FIG. 6 is a cross-sectional side view of the arrangement taken on a line 6-6 in FIG. 5 showing the arrangement in a closed configuration.

FIG. 7 is a cross-sectional side view of the arrangement taken on a line 6-6 in FIG. 5 showing the arrangement in an open configuration.

FIG. 8 is a perspective view of the arrangement of FIG. 5.

### DESCRIPTION OF DRAWINGS

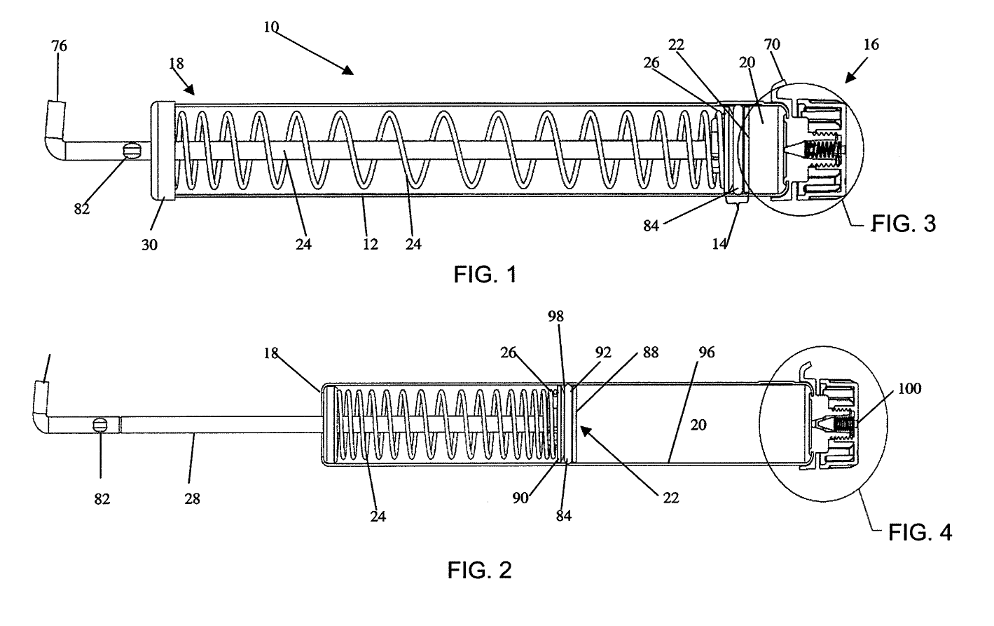

FIG. 1 of the enclosed representations illustrates a pneumatic door closer 10 according to invention which includes a cylinder 12 to which a piston 14 is slidingly engaged for movement between a first end 16 of the cylinder and a second end 18 of the cylinder. A chamber 20 is formed between a leading end 22 of the piston and the first end and which is pressurised when the piston is moved towards the first end. The piston is biased towards the first end with a compression spring 24 and acts between a trailing end 26, which opposes the leading end, of the piston and the second end of the cylinder. A rod 28 extends from the trailing end towards the second end and extends through an end cap 30 which is fixed to the second end 18 so that the compression spring can be compressed against the end cap without disengaging the end cap from the second end.

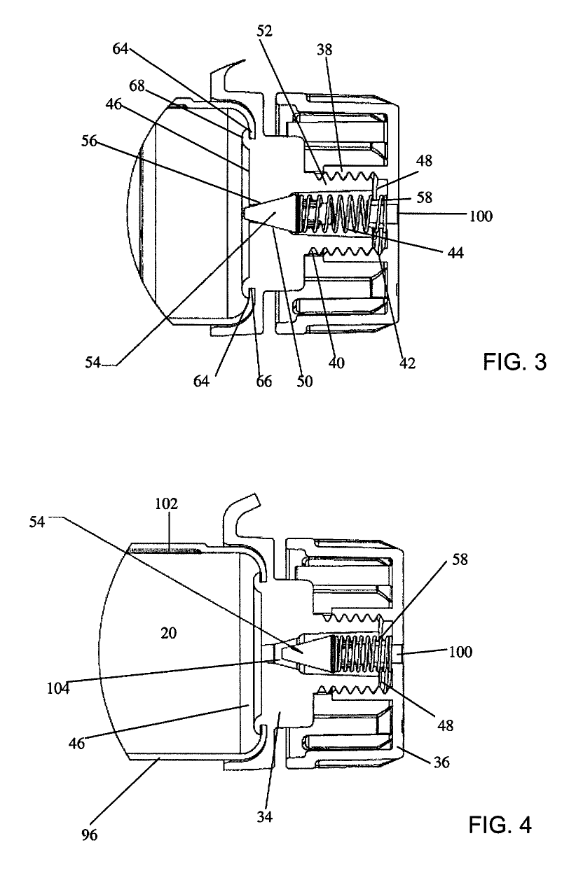

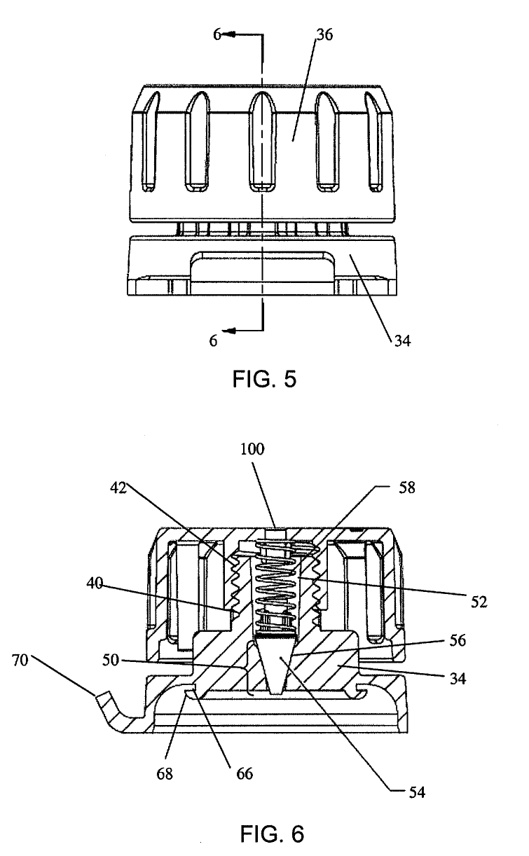

FIGS. 3 to 7 show in greater detail an adjustment arrangement 32 which includes a valve body 34 and an adjustment member or cap 36 which is rotatably attached to the valve body. Referring to FIG. 3, an outer section 38 of the valve body carries a screw thread formation 40 which is complimentary to and interengageable with a screw thread formation 42 of the cap. Thus, the cap can be screwed onto the valve body. The valve body has a passage 44 which extends through the valve body from an inner end 46 to an outer end 48 thereof. The passage has a first portion 50 which extends partly into the valve body from the inner end and which is flared towards the outer end and a second portion 52 which extends from the first portion to the outer end of the valve body.

A valve plug 54 is seated inside the passage 44 on a valve seat 56 which is formed by the first portion 50. A compression spring 58 is positioned between the cap 36 and the valve plug form and which biases the valve plug into sealing engagement with the valve seat. Rotational movement of the cap in a clockwise direction 60, see FIG. 8, results in an increase in the biasing force applied by the compression spring 58 on the valve plug. Conversely, rotational movement of the cap in an anticlockwise direction 62 results in a decrease in the biasing force applied to by the compression spring 58 on the valve plug.

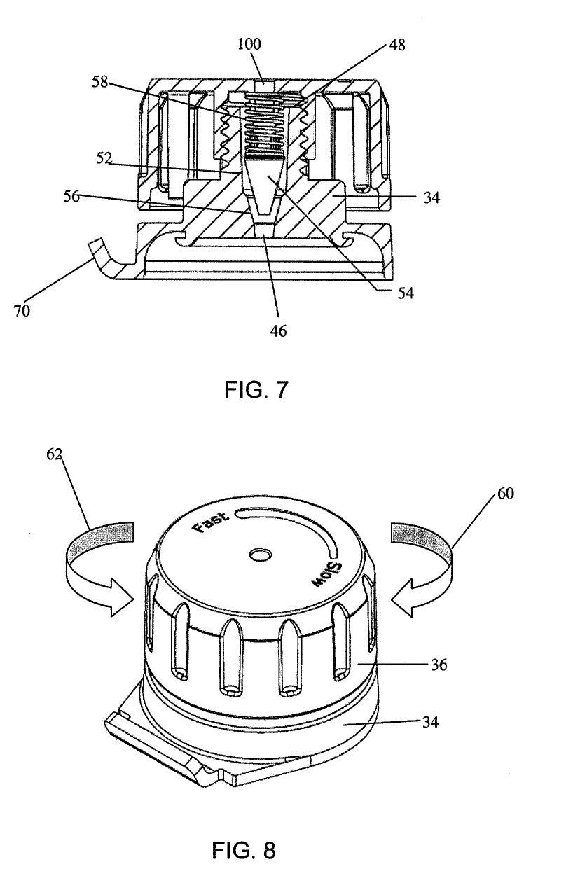

The adjustment arrangement 32 is associated with the first end 16. FIGS. 6 and 7 show the adjustment arrangement 32 before the valve body 34 is crimped on to the first end. This is achieved by positioning ends 64 of the cylinder inside a groove 66 which is formed on the inner end 46 of the valve body and thereafter crimping an edge 68 of the groove the ends 64.

The valve body 34 has a formation or clip 70 which is engaged with a bracket 72, not shown, which, in turn, is secured to a door 74 also not shown. A free end 76 of the rod 28 is shaped so that it can be hooked onto a bracket 78, not shown, which is secured to a frame 80, not shown, to which the door is pivotally attached.

A stop formation 82 is formed on the rod 28 which acts against the end cap 30 so that the movement of the piston 14 towards the first end 16 under the biasing force of the compression spring 24, is stopped at a predetermined position.

The piston 14 has a sealing ring 84 which is movably mounted to a retaining member 88 (see FIG. 2). A head portion of the retaining member 88 is positioned so that the head portion extends perpendicularly relatively to the rod 28 inside the cylinder 12. Toe portion 90 of the retaining member is conical shaped. The sealing ring is mounted to the retaining member between the head and toe portions and is dimensioned so that the sealing ring fits snugly inside the cylinder 12. Movement of the piston towards the second end 18 causes the sealing ring to engage with the head portion. Conversely, movement of the piston towards the first end 16 causes the sealing ring to engage with the toe portion. The head portion is profiled so that air can pass between the sealing ring and the retaining member. For example, an inner surface 92 of the head portion may have a corrugated profile so that air can pass between the ring and the inner surface into the chamber 20. Alternatively, the inner surface 92 may be formed with a plurality of apertures 94, not shown, which extend through the head portion and through which air can pass into the chamber.

However, when the sealing ring is engaged with the toe portion, the conical shape of this portion guides the sealing ring 84 towards an inner surface 96 of the cylinder. This increases the seal which may be formed between the ring and the inner surface. Additionally, an operative surface 98 of the toe portion is smooth so that engagement of the sealing ring with the toe portion established as a seal between the ring and the toe portion. Thus, the seal established between respectively the inner surface and the toe portion substantially prevents air to escape from the chamber 20. This results in the air inside the chamber to become pressurised as the piston moves towards the first end 16.

The first end 16 is sealed by the arrangement 32. A seal is established between the valve plug 54 and the valve seat 56. However, the force with which the valve plug is engaged with the valve seat, is dependent on the force which is exerted by the compression spring 58 on the valve plug. The seal established between the valve plug and the valve seat will only be broken when a force is applied to the valve plug which is greater than a force being applied by the compression spring to the valve plug.

FIG. 2 shows the pneumatic door closer at 10 in use. The piston 14 has been moved towards the second end 18 as a result of pivotal movement of the door 74 relatively to the frame, i.e. by opening of the door. The movement of the door is transferred to the piston via the rod 28. The compression spring 24 is compressed as the piston is moved towards the second end. Once the door is released by a person, not shown, who has opened the door, the resilience of the compression spring will cause the piston to move towards the first end 16. The potential energy created by the compression of the compression spring 24 will be converted in kinetic energy which accelerates the piston towards the first end so that the air inside the chamber 20 is pressurized. At some point the air pressure inside the chamber will be such so that a force is exerted on the valve plug 54 which is greater than a force which is placed on the valve plug by the compression spring 58. At this point the seal between the valve plug and the valve seat 56 is broken, as is shown in FIGS. 4 and the 7, so that air can escape from the chamber through the passage 44 to atmosphere via a hole 100 formed in the cap 36.

Referring to FIG. 8, movement of the cap 36 in the clockwise direction 60 compresses the compression spring 58 onto the valve plug 54 so that a stronger seal is established between valve plug and the valve seat 56. Consequently, a higher level of air pressure is required inside the chamber 20 before the seal between the valve plug and the valve seat is broken due to the increased force being applied to the valve plug by the compression spring. This results in the door 74 taking an increased period of time before being moved to a closed position by the pneumatic door close 10 since it will take the compression spring 24 an increased period of time to pressurised the air inside the chamber 20 to a sufficient level so that the seal between the valve plug and the valve seat is be broken.

Conversely, movement of the cap 36 in the anticlockwise direction 62 decreases the force with which the compression spring 58 is engaged with the valve plug 54. This decreases the strength of the seal established between the valve plug and the valve seat 56 because the compression of the compression spring is reduced. Since a weaker seal is established between the valve plug and the valve seat, less air pressure is required to break the seal so that the door 74 is allowed to move quicker to a closed position as the compression spring 24 will take a reduced amount of time to pressurised the air inside the chamber to a sufficient level at which the seal between the valve plug and the valve seat is broken.

The force required to compress the compression spring 24 is substantially greater than a force required to compress the compression spring 58. Consequently, the compression spring 58 will yield, i.e. by compressing, before the compression spring 24 will yield. This reduces the likelihood of the air inside the chamber 20 being pressurised to level which will result in the piston 14, after the door has been partially moved towards the closed position, to being forced back towards the second end 18 so that the compression spring 24 is compressed.

Referring to FIG. 4, the inner surface 96 is formed with a recess 102 which allows air to escape from the chamber 20 once the ring 84 is positioned over the recess. This results in any air pressure still present in the chamber from being quickly released so that the piston 14 can be accelerated towards the first end 16 until the stop formation 82 engages with the end cap 30. Thus, the last bit of air pressure is quickly released so that the door 74 can be accelerated towards the close position and thereby reducing the likelihood of the door not been properly closed.

The compression of the compression spring 58 allows this valve plug to be movable towards the cap 36. This allows a gap 104 between the valve plug and the valve seat 56 to be widened to accommodate a greater flow of air though the passage 44. Typically this will happen when the piston 14 is moved rapidly towards the first end 16, for example when the door 74 has been released by the user from the fully opened position. The valve plug is pushed back into the passage 44 against the biasing force of the compression spring 58 by the pressured air inside the chamber 20. Consequently, the gap is formed to the extent which is required to allow proper venting of the pressured air 20 from the chamber.

The invention provides a pneumatic door close which incorporates a valve assembly which is responsive to air pressure inside a chamber. A seal established by the valve assembly is broken once the air pressure exceeds a level at which a force is exerted on a valve plug of the valve assembly which is greater than an opposite force which is being applied to the valve plug by a compression spring. The resilience of the compression spring allows a suitable gap to be formed between the valve plug and the valve seat so that sufficient volume of air can be vented from the chamber without allowing a door to which the pneumatic door closer is attached, to “bounce”

The foregoing embodiments are illustrative only of the principles of the invention, and various modifications and changes will readily occur to those skilled in the art. The invention is capable of being practiced and carried out in various ways and in other embodiments. It is also to be understood that the terminology employed herein is for the purpose of description and should not be regarded as limiting.

The term “comprise” and variants of the term such as “comprises” or “comprising” are used herein to denote the inclusion of a stated integer or stated integers but not to exclude any other integer or any other integers, unless in the context or usage an exclusive interpretation of the term is required.

Any reference to publications cited in this specification is not an admission that the disclosures constitute common general knowledge in Australia.

1. A pneumatic door closer which includes a cylinder which has a first end and an opposed second end; a piston which is slidingly engaged with the cylinder and which is biased towards the first end; a valve plug, a valve seat and a biasing member to bias the valve plug into sealing engagement with the valve seat to regulate the flow of air from the cylinder; and an adjustable assembly associated with the valve plug to vary the biasing force exerted on the valve plug thereby varying level of air pressure required inside the chamber before the valve plug is disengaged from the valve seat so that air is allowed to escape from the cylinder.

2. A pneumatic door closer as claimed in claim 1 wherein the piston includes an elongate rod and a piston head mounted coaxially inside the cylinder, one portion of the rod securable to a moveable element or a surround of the moveable element and the cylinder securable to the other of the moveable element or a surround of the moveable element.

3. A pneumatic door closer as claimed in claim 2 wherein opening the moveable element causes the piston to move within the cylinder from a biased condition thereby creating a partial vacuum in the cylinder which draws air in from outside the cylinder.

4. A pneumatic door closer as claimed in claim 3 wherein the biasing member is provided to cause the piston to move back the biased condition when the moveable element is released.

5. A pneumatic door closer as claimed in claim 1 wherein a portion of the adjustable assembly forms an end cap for closing one end of the cylinder.

6. A pneumatic door closer as claimed in claim 1 wherein a biasing spring is used to bias the valve plug towards the valve seat.

7. A pneumatic door closer as claimed in claim 5 wherein the valve body forms an end cap for closing one end of the cylinder, the valve body having a passage which extends therethrough from an inner end of the valve body to an outer end of the valve body.

8. A pneumatic door closer as claimed in claim 7 wherein the passage has a first portion which is flared towards the outer end of the valve body to form the valve seat so that a cross sectional diameter of the valve seat gradually increases from the inner end to the outer end.

9. A pneumatic door closer as claimed in claim 8 wherein the valve plug is generally cone-shaped and is dimensioned so that the valve plug corresponds to the valve seat.

10. A pneumatic door closer as claimed in claim 7 wherein a section of the valve body contains a screw thread formation which is complimentary to and interengageable with a screw thread formation of an adjustment member so that the adjustment member can be screwed onto the valve body.

11. A pneumatic door closer as claimed in claim 10 wherein a compression spring is positioned between the adjustment member and the valve plug so that the valve plug is biased by the compression spring into sealing engagement with the valve seat.

12. A pneumatic door closer as claimed in claim 10 wherein the adjustment member is a rotatable knob located at an outermost end of the adjustable assembly.

13. A pneumatic door closer as claimed in claim 11 wherein the adjustment member is operatively associated with the valve plug and the compression spring to adjust the actuating pressure required to open the valve by disengaging the valve plug from the valve seat.

14. A pneumatic door closer as claimed in claim 13 wherein the adjustment member is rotatably moveable relative to the valve body to adjust the compression of the compression spring.

15. A pneumatic door closer as claimed in claim 13 wherein the compression spring is positioned between the valve plug and the adjustment member so that rotational movement of the adjustment member towards the cylinder causes the level of compression in the compression spring to increase by shortening the effective length of the spring.

16. A pneumatic door closer as claimed in claim 15 wherein movement of the adjustment member away from the cylinder decreases the level of compression in the compression spring by increasing the effective length of the spring.

17. A pneumatic door closer as claimed in claim 1 wherein a portion of greater diameter that the remainder of the cylinder is formed in an inner side wall of the cylinder allowing the air to move past the piston when the piston is at a predetermined position relative to the cylinder.

18. A pneumatic door closer as claimed in claim 17 wherein the portion of greater diameter is located towards but not at a first end of the cylinder, being the end of the cylinder to which the piston is biased.
